(19) United States
(12) Patent Application Publication
(10) Pub. No.: US 2026/0129424 A1
(43) Pub. Date: May 7, 2026

(54) MECHANISMS TO AVOID NONCE REUSE FOR SEAMLESS MOBILITY DOMAIN ROAMING

(71) Applicant: Cisco Technology, Inc., San Jose, CA (US)

(72) Inventors: Binita GUPTA, San Diego, CA (US); Brian D. HART, Sunnyvale, CA (US); Stephen M. ORR, Wallkill, NY (US)

(21) Appl. No.: 19/379,696

(22) Filed: Nov. 4, 2025

Related U.S. Application Data
(60) Provisional application No. 63/716,645, filed on Nov. 5, 2024.

(51) Int. Cl. H04W 8/14; H04W 12/037; H04W 76/15

(52) U.S. Cl. CPC H04W 8/14; H04W 12/037; H04W 76/15

(57) ABSTRACT

In a mobility domain (e.g., a seamless mobility domain), a roaming counter value is provided to a target access point (AP) which the target AP can use to generate a nonce for encrypting data transmitted to a roaming non-AP multi-link device (MLD). That is, the non-AP MLD may be roaming from a current (or serving) AP to the target AP. The roaming counter is incremented each time the non-AP MLD roams in the mobility domain. Thus, each time the non-AP MLD roams, the updated roaming counter is provided to the new target AP MLD. Because the roaming counter is incremented each times there is a roam, even in a buggy implementation where the same PN is reused, the nonce will be different due to the roaming counter being different.

### CROSS-REFERENCE TO RELATED APPLICATIONS

This application claims benefit of co-pending U.S. provisional patent application Ser. No. 63/716,645 filed Nov. 5, 2024. The aforementioned related patent application is herein incorporated by reference in its entirety.

### TECHNICAL FIELD

Embodiments presented in this disclosure generally relate to using a roaming counter to generate a nonce for cryptographic encryption/decryption of MAC Protocol Data Units (MPDUs) between a non-access point (AP) multi-link device (MLD) and an AP MLD in a Seamless Mobility Domain (SMD).

### BACKGROUND

SMD roaming has been proposed in ultra-high reliability (UHR)/IEEE 802.11bn for seamless/improved roaming. In SMD roaming, an SMD is defined that comprises multiple access point (AP) multi-link devices (MLDs) across which a non-AP MLD can perform seamless roaming. In a distributed SMD architecture, each AP MLD in the SMD has a separate MAC-Service Access Point (SAP) to the distribution system (DS). A non-AP MLD associates to the SMD/SMD-management entity (ME) in an SMD architecture. In a shared pairwise transit key (PTK) mode (also referred to as Per-SMD PTK mode) defined for an SMD, a single PTK (and pairwise master key (PMK)) is maintained for the non-AP MLD that is shared/used across all AP MLDs of that SMD. This enables faster roaming for a non-AP MLD between AP MLDs of an SMD, since no PTK regeneration is needed. Also, as part of seamless roaming, context (such as stream classification service (SCS) agreements, block acknowledge (BA) agreements, sequence numbers (SNs), packet numbers (PNs)) is transferred from the old AP MLD (also referred to as the serving AP MLD) to a target AP MLD to reuse already established context and maintain data continuity.

After a shared PTK is established for a non-AP MLD as part of association to an SMD/SMD-ME, the PTK is used for cryptographic encryption/decryption of MPDUs between the non-AP MLD and the AP MLD. To avoid security risks, it is desirable and often required that the Nonce is never reused for a given PTK when performing encryption/decryption of MPDUs with that PTK. For a shared PTK mode of an SMD, the same PTK is shared across AP MLDs of the SMD, hence it is important to ensure that the Nonce values are never reused by two different AP MLDs within the SMD when the non-AP MLD roams from one AP MLD to the other AP MLD.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates providing a roaming counter to a target AP MLD to use for nonce generation, according to one embodiment.

FIG. 2 is a flowchart for generating a nonce using a roaming counter, according to one embodiment.

FIG. 3 is a workflow generating a nonce using a roaming counter for Galois/Counter Mode Protection encryption, according to one embodiment.

FIG. 4A is a flowchart for maintaining a roaming sequence number to use as a roaming counter, according to one embodiment.

FIG. 4B is a flowchart for performing rekeying when a roaming sequence number is about to wrap, according to one embodiment.

FIG. 5 is a MAC protocol data unit for transmitting a roaming counter, according to one embodiment.

FIG. 6 is a workflow to decrypt an encrypted MPDU by generating a nonce that uses a roaming counter value for GCMP decryption, according to one embodiment.

FIG. 7 is a flowchart for maintaining a PN with an embedded roaming counter, according to one embodiment.

FIG. 8 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP that includes one or more memories and one or more processors communicatively coupled to the one or more memories, wherein the one or more processors are configured to, individually or collectively, perform operations. The operations includes receiving a roaming counter value indicating a number of times a non-AP MLD has roamed between APs in a SMD where the AP is part of the SMD, generating one or more nonce values using the roaming counter value, and encrypting wireless traffic transmitted to the non-AP MLD using the one or more nonce values.

One embodiment presented in this disclosure is a non-AP device that includes one or more memories and one or more processors communicatively coupled to the one or more memories, wherein the one or more processors are configured to, individually or collectively, perform operations. The operations includes determining to roam to a target AP in a SMD, incrementing a roaming counter value indicating a number of times the non-AP device has roamed in the SMD, and transmitting the roaming counter value directly or indirectly to the target AP where the target AP is configured to use the roaming counter value to generate a one or more nonce values for encrypting data transmitted to the non-AP device.

### Example Embodiments

Some SMDs can use a shared PTK among the AP MLDs within the SMD for a non-AP MLD, meaning the same PTK is used/shared across each AP MLD of that SMD for the non-AP MLD. That is, each AP MLD in the SMD may use the same shared PTK when transmitting data to the same non-AP MLD (e.g., a user device such as a smartphone, tablet, laptop, etc.). Current encryption techniques (e.g., Galois/Counter Mode Protection (GCMP) and Counter Mode Cipher (CCM) Mode Protocol (CCMP)) use a nonce to add randomness to the encryption process. However, there may be situations where the same nonce is reused by multiple AP MLDs as the non-AP MLD roams between the AP MLDs. This can result in a security risk. As an example, the nonce may be generated based on an AP MLD MAC address and a PN that is incremented each time a data frame is transmitted as in 802.11 baseline. This SMD BSS transition (ST) is shown below:
Nonce=(AP MLD MAC Address∥PN), where “∥” indicates a concatenation operation).
Because the PN is constantly being incremented, it adds randomness into the encryption and because of the different AP MLD MAC addresses the nonce used by different APs will be different. However, there may be a situation where the non-AP MLD roams to a first AP MLD in the SMD and then roams back to a second AP MLD, which is the previous AP MLD to which the non-AP MLD was connected. In a buggy implementation, the AP MLDs may not properly exchange an incremented PN which means the second AP MLD may use a same PN it used previously when communicating with the non-AP MLD. This means the same nonce may be used to encrypt different data transmissions to the non-AP MLD, since the AP MLD MAC address and PN may end up being same in this case for different data frames, thereby causing a security risk.

The embodiments herein propose enhancements to avoid nonce reuse across AP MLDs on an SMD during the SMD roaming. For instance, to prevent nonce reuse, a roaming counter (e.g., a roaming sequence number or a portion of a PN) is provided to a target AP MLD which the target AP MLD can use as an input to generate a nonce for encrypting data transmitted to the roaming non-AP MLD. That is, the non-AP MLD may be roaming from a current (or serving) AP MLD to the target AP MLD. The roaming counter is incremented each time the non-AP MLD roams. Thus, each time the non-AP MLD roams, the updated roaming counter is provided to the new target AP MLD. Because the roaming counter is incremented each time there is a roam, even in a buggy implementation where the same PN might get reused when a non-AP MLD roams back to its previously serving AP MLD, the nonce will be different due to the roaming counter being different. The nonce computation used for cryptographic encryption/decryption of MPDUs is modified as shown below:

Nonce = (AP MLD MAC Address || PN || Roaming
counter), where “||” indicates a
concatenation operation).

There are several different techniques for providing a roaming counter to the target AP MLD. In one embodiment, the non-AP MLD maintains a roaming sequence number that the non-AP MLD increments each time it roams. The roaming sequence number is initialized to a value 0 (or another value) when the non-AP MLD associates with the SMD/SMD-ME and then this roaming sequence number is incremented by the non-AP MLD for every roam within the SMD. In one embodiment, the roaming sequence number could be 4/6/8/10/12/14/16 bits long. When deciding to roam to a new (target) AP MLD, the non-AP MLD can provide the incremented roaming sequence number as part of the roaming messages exchange with the serving AP MLD (e.g., the current AP MLD) or the target AP MLD.

In one embodiment, the non-AP MLD provides the roaming sequence number as part of the roaming preparation request (e.g., in an ST preparation request defined in the 802.11bn amendment) to the serving AP MLD. In one embodiment, the non-AP MLD may also (or instead of) provide the roaming sequence number as part of the roaming execution request (e.g., in an ST execution request defined in the 802.11bn amendment) sent to the serving AP MLD. The serving AP MLD forwards the roaming sequence number to the target AP MLD as part of context transfer done for the roaming. In one embodiment, the non-AP MLD may also provide the roaming sequence number as part of the roaming execution request (e.g., the ST execution request) sent directly to the target AP MLD. In one embodiment, the non-AP MLD may provide the roaming sequence number as part of a roaming request sent to the target AP MLD (for the case referred to as “roaming through target AP”) for last-minute/panic roaming. If the target AP MLD accepts the roaming request, then it uses the roaming sequence number as an input to the nonce generation.

The nonce computation used for cryptographic encryption/decryption of MPDUs is modified as shown below, where the roaming sequence number is used as an input to nonce computation:

Nonce = (AP MLD MAC Address || PN || Roaming
Sequence Number), where “||” indicates a
concatenation operation).

In one embodiment, if the roaming sequence number is about to wrap around, then rekeying of the PTK may be performed to avoid any security risk of same nonce value being used (due to wrap around) with the same PTK. For example, if the roaming sequence number is 6 bits long, then once it reaches a value close to 31 (e.g. value 29 or 30 or 31), then the PTK is rekeyed. The PTK rekeying can be initiated by the AP MLD or the non-AP MLD can request AP MLD to perform PTK rekeying. PTK rekeying can be performed using procedure defined in 802.11 baseline e.g. 4-way handshake for PTK rekeying or another optimized procedure for rekeying.

In another embodiment, the roaming counter is a portion of the PN. For example, the most significant bits (MSB) of the PN (e.g., 4/6/8/10/12 MSBs of the PN field, referred to as PN-MSB field) may be used for a roaming counter. Each time the non-AP MLD roams, it can increment the PN-MSBs field of the PN. The remaining or least significant bits (LSBs) of the PN (PN-LSBs) can be incremented each time an encrypted data packet/MPDU is sent and in this case the PN-MSBs field of the PN is not incremented. When the target AP MLD receives the PN (e.g., from the currently serving AP MLD as part of context transfer), the target AP MLD knows the PN-MSBs field of the PN is a roaming counter and since the entire PN gets used to generate the nonce to encrypt data transmitted to the non-AP MLD in DL, the roaming counter (the PN-MSBs field) is included as part of the nonce generation. Similar to what was described above for the roaming sequence number, if the PN-MSBs field value is about to wrap around, then a PTK rekeying may be performed to avoid any potential security risk.

The roaming counter can be maintained by the non-AP MLD which increases the likelihood the counter value will be accurately maintained. In some embodiments, the non-AP MLD transmits the roaming counter to the currently serving AP MLD (e.g., as part of roaming preparation request or roaming execution request or another frame) which then forwards the roaming counter to the target AP MLD as context data. However, in other embodiments, the non-AP MLD may transmit the roaming counter directly to the target AP MLD as described above.

In another embodiment, the roaming counter can be maintained by the currently serving AP MLD (rather than the non-AP MLD) which then passes on the roaming counter to the target AP MLD when the non-AP MLD roams. That is, each serving AP MLD can increment the roaming counter each time the non-AP MLD announces its intention to roam and then pass on the incremented value to the new target AP MLD. The target AP MLD then uses the roaming counter value as part of the nonce generation when encrypting/decrypting DL data MPDUs (e.g., using CCMP or GCMP process).

In one embodiment, for the seamless roaming (e.g., ST), if the non-AP MLD prepares multiple target AP MLDs and then performs roaming execution with one of those target AP MLDs, the roaming counter (or the roaming sequence number) is incremented only once (i.e., the roaming counter is not incremented for roaming preparation for each target AP MLD). In one embodiment, if after initiating roaming preparation, the non-AP MLD does not complete roaming execution for any reason and stays connected with the current AP MLD, then the same roaming counter is used for a subsequent ST.

While an SMD is described, the embodiments herein can be used in other types of mobility domains where APs use a shared PTK to encrypt data for a particular non-AP device.

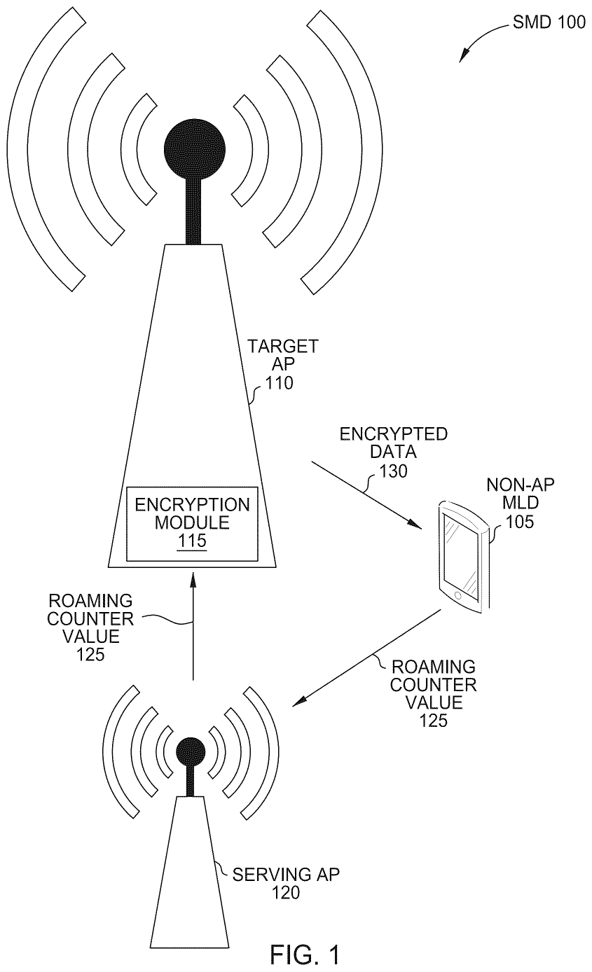

FIG. 1 illustrates providing a roaming counter value 125 to a target AP 110 to use for nonce generation for sending encrypted DL MPDUs, according to one embodiment. FIG. 1 illustrates a SMD 100 that includes multiple AP MLDs. The SMD 100 is a logical network grouping of AP MLDs that allows a non-AP MLD 105 (e.g., a user device) to move between them seamlessly without losing connectivity and maintaining a continuous session. The SMD 100 enables seamless roaming by enabling APs to share client context and perform pre-computed security key generation (PTK) before a device roams, minimizing disruption, especially for real-time applications.

In the operation illustrated in FIG. 1, the non-AP MLD 105 (e.g., a user device) is currently associated with the SMD/SMD-ME and connected via a serving AP 120 (e.g., a serving AP MLD). However, the non-AP MLD 105 has announced to the serving AP 120 that the non-AP MLD 105 intends to roam to a target AP 110 (e.g., a target AP MLD). In this example, the non-AP MLD 105 transmits a roaming counter value 125 (e.g., a roaming sequence number that is maintained by the non-AP MLD) to the serving MLD 120 that indicates the number of times the non-AP MLD 105 has roamed within the SMD 100. That is, each time the non-AP MLD 105 determines to roam to a different AP/AP MLD in the SMD 100, the non-AP MLD 105 increments the roaming counter. The non-AP MLD may provide the roaming counter value 125 to the serving AP MLD 120 in a roaming preparation request (e.g. in an ST preparation request defined in the 802.11bn amendment). In one embodiment, the non-AP MLD may also (or instead) provide the roaming sequence number as part of the roaming execution request (e.g., in an ST execution request defined in the 802.11bn amendment) sent to the serving AP MLD 120.

The serving AP MLD 120 forwards the roaming counter value 125 to a target AP MLD 110—i.e., the AP that the non-AP MLD 105 has selected as its roaming target. That is, while the non-AP MLD 105 plans to roam to the target AP 110 in the future, it currently remains connected to the serving AP 120.

The roaming counter value 125 can be part of the roaming context that the serving AP MLD 120 provides to the target AP MLD 110 via, e.g., a backhaul or over the distribution system (DS). This roaming context can include agreements or capabilities, association context, a roaming MAC address (e.g., a MAC address used as Transmitter Address (TA) in roaming management frames when performing roaming). In one embodiment, the transferred context can include the shared PTK and/or the PMK of the non-AP MLD that the target AP MLD 110 can use to communicate securely with the non-AP MLD 105. That is, the serving AP MLD 120 can transfer this information to the target AP MLD 110 securely (or the target AP 110 can fetch this information from the serving AP MLD 120 securely).

In one embodiment, the roaming counter value is provided directly to the target AP MLD as part of the roaming execution request (e.g., the ST execution request) sent directly to the target AP MLD (not shown in FIG. 1). In one embodiment, the non-AP MLD may provide the roaming sequence number as part of a roaming request sent to the target AP MLD (for the case referred to as “roaming through target AP”) for last-minute/panic roaming (not shown in FIG. 1). If the target AP MLD accepts the roaming request, then target AP MLD uses the roaming counter as an input to the nonce generation used for cryptographic encryption/decryption of MPDUs.

The target AP 110 includes an encryption module 115 which can be software, hardware, or a combination of both that encrypts data packets or frames transmitted as encrypted data 130 to the non-AP MLD 105. As described in more detail below, the encryption module 115 can use roaming counter value 125 to generate a nonce (along with other information such as an AP MLD MAC address and a PN value) for encrypting downlink (DL) data for the non-AP MLD 105.

While FIG. 1 illustrates the non-AP MLD 105 incrementing the roaming counter value 125, in other embodiments, the serving AP MLD 120 may increment the roaming counter value 125 (instead of the non-AP MLD 105). Further, while FIG. 1 illustrate the serving AP MLD 120 transmitting the roaming counter value 125 to the target AP 110, in another embodiment, the non-AP MLD 105 transmits the roaming counter value 125 directly to the target AP MLD 110.

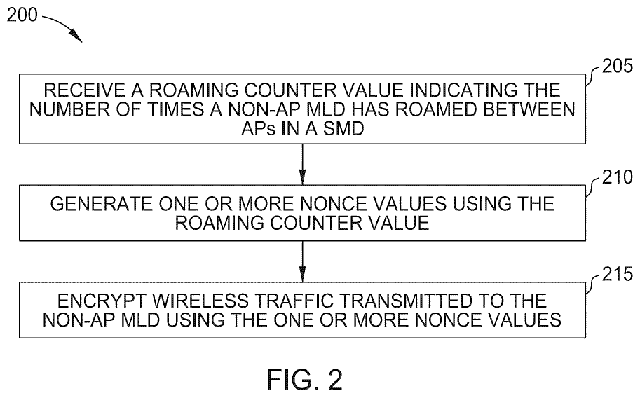

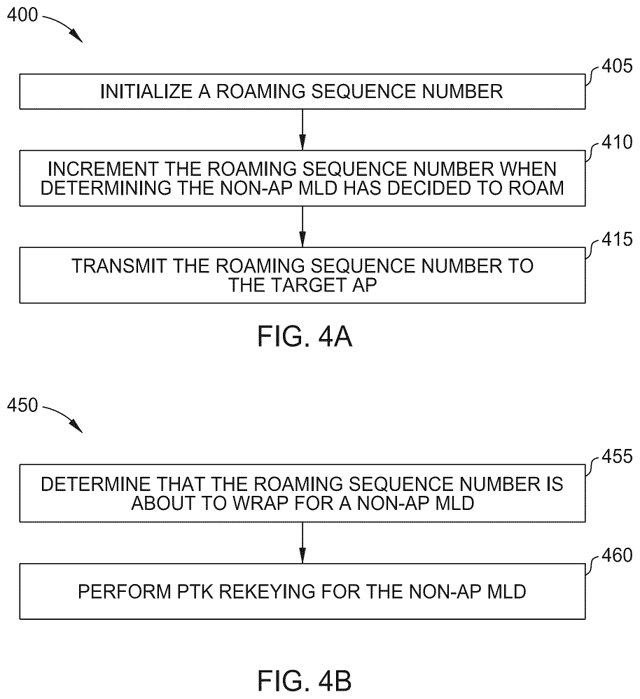

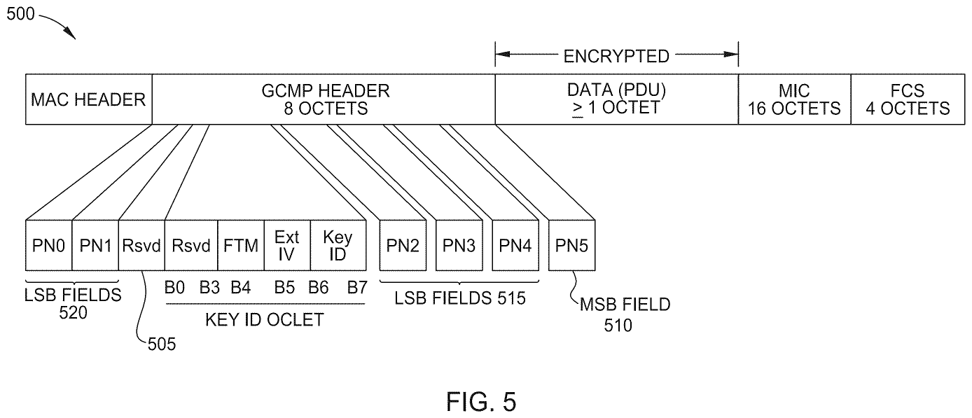

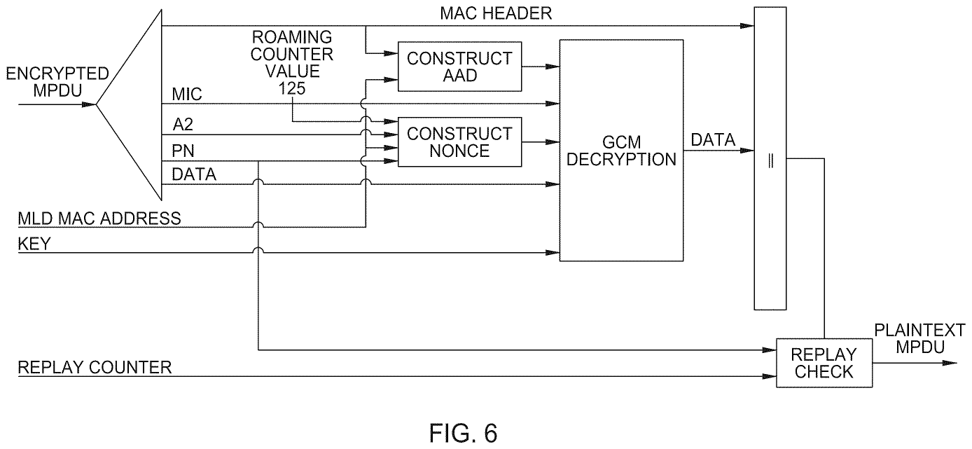

FIG. 2 is a flowchart of a method 200 for generating a nonce using a roaming counter, according to one embodiment. At block 205, a target AP (e.g., the target AP 110 in FIG. 1) receives a roaming counter value indicating the number of times a non-AP MLD (e.g., a user device) has roamed between APs in a SMD (e.g., the SMD 100 in FIG. 1). The roaming counter value may be generated using any suitable technique. FIGS. 4 and 5 illustrates a roaming counter value implemented using a roaming sequence number that is transmitted in a GCMP MPDU while FIG. 6 illustrates a roaming counter value that is embedded into a portion of a PN (e.g., the MSBs of a PN).

The target AP can receive the roaming counter value from the AP that is currently serving the non-AP MLD (e.g., as part of roaming context transmitted over a backhaul) or directly from the non-AP MLD. For example, the non-AP MLD can provide the roaming counter to the target AP MLD as part of a roaming execution request (i.e., a ST execution request) sent directly to the target AP MLD or as part of a roaming request sent directly to target AP MLD for last-minute/panic roam scenario. In one embodiment, the non-AP MLD may provide the roaming counter value to the target AP MLD in another management frame, e.g., a UHR Link Reconfiguration Notify frame sent to the target AP MLD.

In one embodiment, the non-AP MLD can use the roaming counter value for nonce generation when encrypting uplink (UL) MPDUs transmitted to the target AP MLD. This may be desirable to avoid any security risk of nonce reuse at the non-AP MLD due to buggy implementation at the non-AP MLD. For example, when the non-AP MLD roams to a second AP MLD (from the first AP MLD) and then roams back to the first AP MLD again, then a buggy implementation may use the same PN, leading to a same nonce value as was used before. Adding a roaming counter to the nonce computation performed by the non-AP MLD can avoid such security risk. In one embodiment, the roaming counter value is part of encrypted UL transmissions in the GCMP or CCMP header fields sent to the target AP MLD by the non-AP MLD. Then the target AP MLD can be informed of the roaming counter value from UL data transmissions sent from the non-AP MLD.

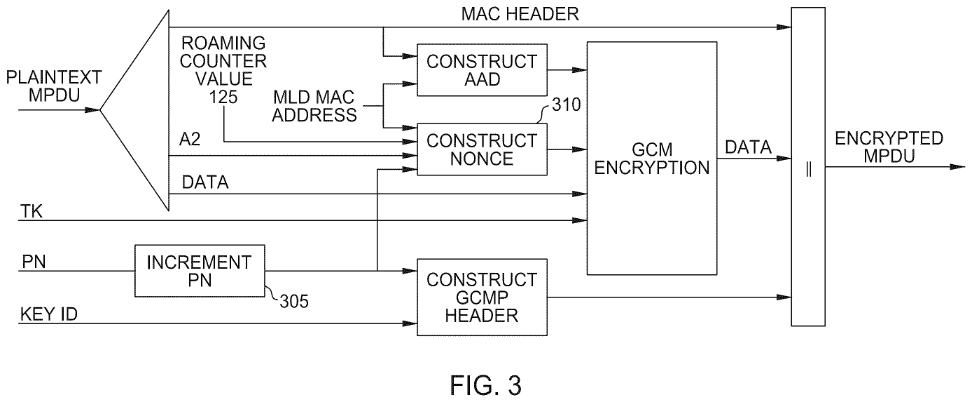

At block 210, the encryption module in the target AP MLD (e.g., the encryption module 115 in FIG. 1) uses the roaming counter values as an input to generate one or more nonce values used for encrypting DL MPDUs. As described above, in one embodiment, the nonce is generated as Nonce=(AP MLD MAC Address∥PN∥Roaming counter). For every DL MPDU, the PN value is incremented and as a result the nonce value is different for every MPDU. Then, at block 215, the target AP MLD uses the generated one or more nonce values for encrypting DL MPDUs. The nonce values can be used in GCMP or CCMP encryption for DL MPDUs. Note that nonces can also be used to generate a PTK, but the embodiments herein describe different nonces that are used after the PTK has already been generated and when the MLD is actively transmitting UL/DL data frames. One example of an encryption system that can use the roaming counter value to generate nonce value used for encryption of an MPDU is illustrated in FIG. 3.

FIG. 3 is a workflow for generating a nonce using a roaming counter value 125 for GCMP encryption of an MPDU, according to one embodiment. For example, the workflow in FIG. 3 can be implemented in the encryption module 115 in FIG. 1. In one embodiment, the workflow in FIG. 3 can also be implemented in the UL encryption of MPDUs at the non-AP MLD, meaning a non-AP MLD can also use the roaming counter value as an input to the nonce generation for encryption of UL MPDUs. In this case, the MLD MAC Address that is used for nonce generation is the non-AP MLD MAC address.

In relevant part, this workflow includes block 305 where a PN is incremented for each MPDU that is encrypted for transmission between the AP MLD and the non-AP MLD. In normal communication between the AP MLD and the non-AP MLD, the transmitter of the encrypted MPDU (either the AP MLD or the non-AP MLD) can increment the PN for each MPDU encryption. This incremented PN serves as one input into block 310 which constructs the nonce for the MPDU encryption. When there is a roam (e.g., a ST between AP MLDs of an SMD), a PN value is transmitted from the currently serving AP to the target AP so the target AP can perform the workflow in FIG. 3.

In addition to receiving the PN, the block 310 also receives the MLD MAC Address which can include the AP MLD MAC Address of the AP MLD performing the workflow (or the non-AP MLD MAC address if the encryption is performed by the non-AP MLD for UL MPDUs). The block 310 also receives the roaming counter value 125. When there is a roam, the roaming counter value 125 can be provided to the target AP by the currently serving AP or the non-AP MLD as discussed at block 205 of the method 200.

In IEEE 802.11be with multi-link operation (MLO), the MPDU encryption/decryption uses PN and AP MLD MAC Address to generate Nonce values. Here, the nonce is generated using 6 octets of the AP MLD MAC Address and six octets of the PN. Similar Nonce generation is used for CCMP encryption as well. In addition, FIG. 3 illustrates that the roaming counter value 125 can also be used to generate the nonce at block 310. For example, the nonce generation in that case can be AP MLD MAC Address (6 octets)∥PN (6 octets)∥ Roaming Counter. The size of the roaming counter can be from few bits to 1 octet or 2 octets—e.g., 4/6/8/10/12/14/16 bits. The roaming counter value 125 can be one octet long (0 to 255 values) or alternatively can be 4 bits long (0 to 15 values) with 4 MSB bits set to always 0 in Nonce computation. The roaming counter value 125 can also be defined to be much longer, e.g. 12 bits or 2 octets or 4 octets.

Returning to the method 200 in FIG. 2, at block 215 the encryption module in the target AP encrypts DL MPDUs transmitted to the non-AP MLD using the nonce values generated with roaming counter used as input. For example, the nonce can be used in the GCMP encryption process illustrated in FIG. 3 to transmit encrypted MPDUs (or Management MAC Protocol Data Unit (MMPDUs) to the non-AP MLD.

FIG. 4A is a flowchart of a method 400 for maintaining a roaming sequence number to be used as a roaming counter, according to one embodiment. That is, method 400 describes a roaming sequence number which is one example of a roaming counter.

At block 405, the non-AP MLD initializes a roaming sequence number in an SMD. For example, when the non-AP MLD first associates with the SMD/SMD-ME through one of the AP MLDs in the SMD, the non-AP MLD initializes the roaming sequence number to zero (or another value).

At block 410, the non-AP MLD (or a currently serving AP MLD) increments the roaming sequence number when determining that the non-AP MLD has decided to roam. For example, the non-AP MLD may increment the roaming sequence number when it has selected a target AP MLD in the SMD to perform SMD BSS transition (ST). Or the currently serving AP may increment the roaming sequence number after the non-AP MLD sends a roaming request to the serving AP MLD to roam to the target AP. For example, the serving AP MLD may increment the roaming sequence number when it receives an ST preparation request or an ST execution request from the non-AP MLD.

As an example, when the non-AP MLD roams to another AP MLD2 in the same SMD, then the roaming sequence number is incremented by 1 (to value 1 assuming the roaming sequence number has just been initialized). The updated roaming sequence number is used by the new target AP MLD (the AP MLD2) in Nonce generation for transmitting encrypted MPDUs to the non-AP MLD. If non-AP MLD roams back to the same old AP MLD (e.g., AP MLD1), the roaming sequence number is incremented again by 1 (to value 2 in this case). The AP MLD1 then uses incremented roaming sequence number in its Nonce generation for transmitting encrypted MPDUs to the non-AP MLD. This avoids any Nonce reuse by AP MLD1 (even if the same PN is mistakenly reused), since the nonce was generated using a different roaming sequence number.

At block 415, the non-AP MLD or the currently serving AP MLD transmit the roaming sequence number to the target AP. For example, the non-AP can transmit the roaming sequence number directly to the target AP MLD in the ST execution request or in a roaming request frame for last-minute/panic roaming case, or the roaming sequence number can be transmitted to the target AP MLD from the currently serving AP MLD.

In one embodiment, where the roaming sequence number is maintained and incremented by the non-AP MLD, the non-AP MLD provides the roaming sequence number in the (Re) Association Request (the initial value) and later provides an incremented value for the roaming sequence number for every roam, in a roaming request management frame (or Reassociation Request if used for roaming) to the AP MLD. The non-AP MLD can provide the roaming sequence number in the ST preparation request, in the ST execution request or in a roaming request frame sent to the target AP MLD for last-minute/panic roaming case, as described above.

In one embodiment, the non-AP MLD uses the roaming sequence number in its nonce generation when transmitting encrypted UL MPDUs to avoid any security risk of nonce reuse at the non-AP MLD. However, such security risk may be small, since the non-AP MLD can directly track or maintain the PN it uses across two AP MLDs of an SMD for encryption of UL MPDUs. Thus, unlike a target AP MLD which relies on the current serving AP MLD to provide the PN, the security risk in the non-AP MLD reusing the same PN and as such is smaller, and the PN may be sufficient to add randomness into the nonce generation when encrypting data at the non-AP MLD. Hence, the use of roaming sequence number in the nonce generation when transmitting encrypted UL MPDUs can be optionally done at the non-AP MLD.

FIG. 4B is a flowchart of a method 450 for performing PTK rekeying when the roaming sequence number is about to wrap. This may be desirable to avoid any security risk of same nonce value being used (due to wrap around or roaming sequence number) with the same PTK. For example, if the roaming sequence number is 6 bits long, then once it reaches a value close to 31 (e.g. value 29 or 30 or 31), then the PTK can be rekeyed. The PTK rekeying can be initiated by the AP MLD or the non-AP MLD can request AP MLD to perform PTK rekeying. By performing PTK rekeying to generate a new PTK for the non-AP MLD, even if the roaming sequence number wraps (e.g. start over to zero) there is no risk of reusing the same nonce for a given PTK (because a new PTK is generated). This procedure may be performed optionally, since in many cases the security risk may be small.

In another related embodiment, the PTK rekeying may be done if the roaming sequence number is about to wrap or when the roaming sequence number wraps around, independent of whether the roaming sequence number is used for nonce computation for encrypted MPDUs. Meaning if a non-AP MLD has roamed enough number of times within the SMD because roaming sequence number is about to wrap or has just wrapped around, then a PTK rekeying can be done for the reason of better security key hygiene (e.g., it may be desired to rekey PTK after certain number of roams of a non-AP MLD and then the size of the roaming sequence number can be set accordingly). For example, if the roaming sequence number is 6 bits long, then the PTK can be rekeyed after every 31 roams. Such a PTK rekeying can be initiated by the AP MLD to which the non-AP MLD is connected, e.g., the target AP MLD can initiate a PTK rekeying after that non-AP MLD has roamed to the target AP MLD (and the target AP MLD has determined that the roaming sequence number has wrapped around).

At block 455 in FIG. 4B, an AP MLD in the SMD may determine that the roaming sequence number is about to wrap for a non-AP MLD. For example, this can be determined by the target AP MLD to which the non-AP MLD has roamed to recently, or by the serving AP MLD to which the non-AP MLD is connected. Such a determination can be made by the AP MLD close to when the roaming sequence number value is about to wrap but may not be exactly at the value after which wrap around will happen, as described above. A non-AP MLD may also determine that the roaming sequence number is about to wrap. At block 460, the AP MLD in the SMD may perform PTK rekeying for the non-AP MLD to generate a new PTK.

FIG. 5 is an encrypted MPDU 500 for GCMP encryption that includes a roaming counter in the header, according to one embodiment. The MPDU 500 is an encrypted MPDU that includes MAC header, GCMP header and encrypted data, message integrity field (MIC), and frame check sequency (FCS). The MPDU 500 is encrypted following the GCMP encryption process as described in FIG. 3 where the nonce generation uses the roaming counter as an input. Any encrypted MPDU transmitted carries PN and roaming sequence number fields that are used for nonce generation, so that the receiving peer entity can use those fields along with PTK to decrypt the MPDU. As defined in baseline 802.11 standard, the 6 octets PN value is carried in the GCMP header in PN0, PN1, PN2, PN3, PN4 and PN6 fields (each being 1 octet long).

FIG. 5 illustrates a blow-out view of the GCMP header for the encrypted MPDU, which includes reserved bits/Rsvd field 505 (1 octet long). In one embodiment, the roaming counter value can be placed in the reserved bits of Rsvd field 505. If the size of the roaming counter is smaller than one octet, then only part of the Rsvd field 505 is used to carry roaming counter.

In one embodiment, the same mechanism is used to carry roaming counter value in the CCMP header for an encrypted MPDU that is encrypted using the CCMP procedure (i.e. in the CCMP header, the roaming counter is carried as part of Rsvd bits). This mechanism of carrying a roaming counter in the GCMP or CCMP header can be used for encrypted DL MPDUs by the AP MLD or can be used for encrypted UL MPDUs by a non-AP MLD. After the peer entity receives the encrypted MPDU, then it would use the received roaming counter and the PN value from the GCMP/CCMP header to generate nonce value for decryption of the MPDU.

FIG. 6 is a workflow to decrypt an encrypted MPDU by generating a nonce that uses a roaming counter value for GCMP decryption (e.g., decapsulation), according to one embodiment. In one embodiment, the roaming counter value is extracted from the GCMP header of the received encrypted MPDU as described in FIG. 5 and is then provided as input to the “Construct nonce” block for generating a nonce to decrypt the MPDU. In one embodiment, the roaming counter may not be included in the GCMP header field, and in that case the entity receiving the encrypted MPDU (either an AP or a non-AP MLD) uses the roaming counter value known to it as an input for nonce generation to decrypt the MPDU. The same mechanism can be following for a CCMP decryption process.

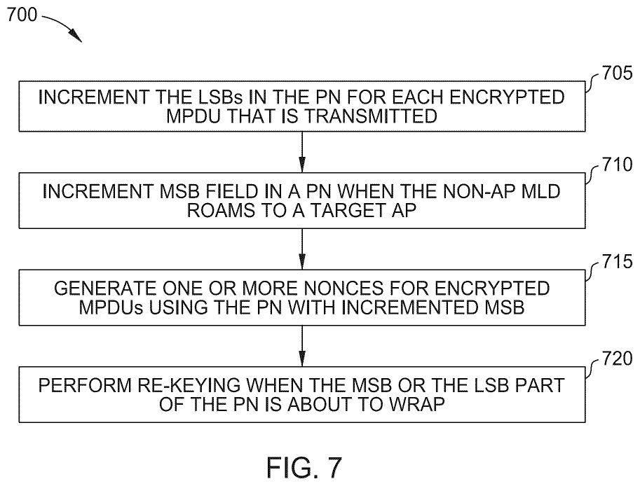

FIG. 7 is a flowchart of a method 700 for maintaining a PN with an embedded roaming counter, according to one embodiment. The method 700 illustrates using a portion of the PN as the roaming counter. This can be done for encrypted DL MPDUs or encrypted UL MPDUs or for both. In this example, MSBs of the PN is used to store a roaming counter value, while the LSBs (or the remaining bits) of the PN is used as a traditional PN value which is incremented for every encrypted MPDU transmitted. As such, method 700 describes embedding the roaming counter value in the PN. The PN field is sent along with the encrypted MPDU as part of GCMP header (or CCMP header) as shown in FIG. 5.

At block 705, the non-AP MLD (or the currently serving AP MLD) increments the LSBs in the PN each time a frame is transmitted. Using FIG. 5 as an example, the PN has six octets labeled PN0-PN5. The LSB fields 515 and 520 (i.e., PN0-PN4) can store the actual PN which is incremented for each transmitted MPDU by the transmitting entity (either the AP MLD or the non-AP MLD). The MSB field 510 (i.e., PN5) specifies the current roaming counter value for the non-AP MLD. Fewer bits than one MSB octet of PN may be used for the roaming counter. For example, 4 or 6 bits in the PN5 can be used for providing roaming counter.

At block 710, when the non-AP MLD roams to a target AP MLD, the MSB field of the PN is incremented. The MSB field of the PN may be incremented by the non-AP MLD or the currently serving AP or the target AP. The PN value that is passed to a target AP MLD from the current serving AP MLD may include an incremented value for MSB field of the PN or the target AP may increment the MSB of the PN when a non-AP MLD roams to the target AP.

The most significant bits of the PN can be one octet (or fewer bits than one octet) or include several octets (e.g., the most significant octet (e.g., PN5 in FIG. 5) or the top 4/6/8/10/12 bits of the PN field which can span across the PN5 and PN4 octets). These MSBs can be used to provide same functionality as the roaming sequence number discussed in FIG. 4, but these embodiments do not add a new roaming sequence number field in the nonce generation since the roaming counter value is embedded within the PN value itself. At block 715, the PN that includes the incremented MSB is used for nonce generation for encrypted MPDUs exchanged between the target AP MLD and the non-AP MLD.

In one embodiment, the PN-MSB field (i.e. the MSBs field of the PN) that includes the roaming counter are set to 0 the first time the non-AP MLD associates to the SMD. In CCMP or GCMP encryption, after initial association of a non-AP MLD to the SMD through an AP MLD1, the PN-MSBS field may be set to 0 in each of the CCMP or GCMP headers for encrypted MPDUs. The Nonce generation can have a PN with its PN-MSBS field set to 0. When the non-AP MLD roams to another target AP MLD2, the PN-MSBS field is incremented by 1. Then the PN with the incremented PN-MSBS field is used for nonce generation for encrypted MPDUs exchanged between the target AP MLD and the non-AP MLD. The incremented PN-MSBS may be used by the target AP MLD for encrypted DL MPDUs and/or may be used by the non-AP MLD for encrypted UL MPDUs.

The CCMP or GCMP header for encrypted UL MPDUs would then have the PN-MSBS field set to 1. The target AP MLD2 would also use a PN-MSBS field of 1 in the DL MPDU encryption. If the non-AP MLD roams back to the same AP MLD1 within the SMD, it will increment the PN-MSBS field to value 2, and then the PN with a PN-MSBS of value 2 is used in the Nonce generation and in CCMP and GCMP header in encrypted UL MPDUs. The old AP MLD1 would then use the PN-MSBS field value 2 in DL MPDU encryption (for nonce generation and PN value in CCMP or GCMP header). Thus, this approach avoids any Nonce reuse when the non-AP MLD roams back to an old AP MLD (e.g. due to ping-pong roaming).

In one embodiment, when a serving AP passes PN value to a target AP MLD as part of roaming context transfer, the serving AP increments the PN-MSBS field in the PN value being sent. This ensures that the target AP MLD uses a different set of PN values. For example, the top p bits (such as p=4/6/8/10/12 bits) from the PN field can be used as a roaming counter value that is incremented when roaming to another AP MLD within the SMD. The rest of the PN bits (48-p bits) are incremented when encrypting MPDUs on the same AP MLD.

Nonetheless, in both the method 400 and the method 700, the size of the CCMP or GCMP header illustrated in FIG. 5 can remain the same, which can make the embodiments herein easier to implement in the current wireless standards.

At block 720, the SMD performs rekeying when the MSBs or the LSBs of the PN are about to wrap. In one embodiment, the SMD may perform rekeying when the LSBs representing the actual packet number of the PN are about to wrap and when the MSBs representing the roaming counter are about to wrap. Or in another embodiments, rekeying may be performed when the LSBs representing the actual packet number of the PN are about to wrap but not with the MSBs representing the roaming counter are about to wrap (or vice versa).

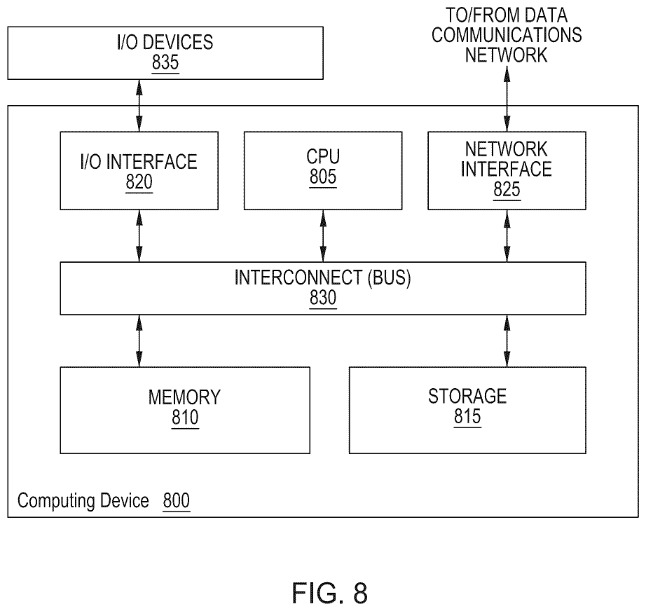

FIG. 8 depicts an example computing device configured to perform various aspects of the present disclosure, according to one embodiment. Although depicted as a physical device, in embodiments, the computing device 800 may be implemented using virtual device(s), and/or across a number of devices (e.g., in a cloud environment). In one embodiment, the computing device 800 corresponds to a network device (e.g., a computing system), such as the APs 110, 120 or the non-AP MLD 105.

As illustrated, the computing device 800 includes a CPU 805 (one or more processors), memory 810 (or memories), storage 815, a network interface 825, and one or more input/output (I/O) interfaces 820. In the illustrated embodiment, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally included to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

The memory 810 can include software programs or application for incrementing a roaming counter or encrypting data using a roaming counter (e.g., using the encryption module 115 in FIG. 1) as discussed above in FIGS. 1-6. Although shown as residing in memory 810, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point (AP), comprising:
one or more memories; and
one or more processors communicatively coupled to the one or more memories, wherein the one or more processors are configured to, individually or collectively, perform operations comprising:
receiving a roaming counter value indicating a number of times a non-AP multi-link device (MLD) has roamed between APs in a seamless mobility domain (SMD), wherein the AP is part of the SMD;
generating one or more nonce values using the roaming counter value; and
encrypting wireless traffic transmitted to the non-AP MLD using the one or more nonce values.

2. The AP of claim 1, wherein the roaming counter value is a roaming sequence number that is initialized to a given value when the non-AP MLD first associates with the SMD and is incremented each time the non-AP MLD roams within the SMD.

3. The AP of claim 2, wherein the AP is an AP MLD, and wherein generating the one or more nonce values is based on the roaming sequence number, a MLD MAC address of the AP MLD, and a packet number (PN).

4. The AP of claim 1, wherein the roaming counter value is the most significant bits of a packet number (PN), wherein the most significant bits of the PN are incremented each time the non-AP MLD roams within the SMD.

5. The AP of claim 4, wherein generating the one or more nonce values is based on a MAC address of the AP and the PN.

6. The AP of claim 1, wherein the AP is a target AP, wherein the non-AP MLD performs a roam to the target AP through a current serving AP in the SMD that is currently serving the non-AP MLD, wherein the roaming counter value is received at the target AP from the current serving AP.

7. The AP of claim 6, wherein the current serving AP receives the roaming counter value from the non-AP MLD, wherein the non-AP MLD increments the roaming counter value each time the non-AP MLD roams within the SMD.

8. The AP of claim 7, wherein the current serving AP receives the roaming counter value from the non-AP MLD as part of a roaming preparation request or a roaming execution request.

9. The AP of claim 1, wherein the roaming counter value is received from the non-AP MLD, wherein the non-AP MLD increments the roaming counter value each time the non-AP MLD roams within the SMD, wherein the roaming counter value is received from the non-AP MLD as part of a roaming request.

10. The AP of claim 1, wherein the roaming counter value is received from a current serving AP in the SMD that is currently serving the non-AP MLD, wherein the AP is a target AP, and wherein the roaming counter value is incremented by the current serving AP when the non-AP MLD performs a roam to the target AP through the current serving AP.

11. The AP of claim 1, wherein the encrypting wireless traffic transmitted to the non-AP MLD further comprises the AP transmitting the roaming counter value as part of a Counter Mode Cipher (CCM) Mode Protocol (CCMP) header field or a Galois/Counter Mode Protection (GCMP) header field of an encrypted MAC Protocol Data Unit (MPDU).

12. The AP of claim 1, wherein the operations further comprise the non-AP MLD using the roaming counter value for generating a one or more second nonce values and encrypting wireless traffic transmitted to the AP using the one or more second nonce values.

13. The AP of claim 12, wherein the encrypting wireless traffic transmitted to the AP further comprises the non-AP MLD transmitting the roaming counter value as part of a CCMP header field or a GCMP header field of an encrypted MPDU.

14. A non-access point (AP) device, comprising:
one or more memories; and
one or more processors communicatively coupled to the one or more memories, wherein the one or more processors are configured to, individually or collectively, perform operations comprising:
determining to roam to a target AP in a seamless mobility domain (SMD);
incrementing a roaming counter value indicating a number of times the non-AP device has roamed in the SMD; and
transmitting the roaming counter value directly or indirectly to the target AP, wherein the target AP is configured to use the roaming counter value to generate a one or more nonce values for encrypting data transmitted to the non-AP device.

15. The non-AP device of claim 14, wherein the roaming counter value is a roaming sequence number that is initialized to a given value when the non-AP device first associates with the SMD and is incremented each time the non-AP device roams within the SMD.

16. The non-AP device of claim 15, wherein the roaming counter value is transmitted indirectly to the target AP by the non-AP device transmitting the roaming counter value to a current serving AP in the SMD that is currently serving the non-AP device, wherein the current serving AP then transmits the roaming counter value to the target AP.

17. The non-AP device of claim 16, wherein the operations further comprise transmitting the roaming counter value to the current serving AP as part of a roaming preparation request or a roaming execution request.

18. The non-AP device of claim 16, wherein the roaming counter value is transmitted directly to the target AP by the non-AP device transmitting the roaming counter value to the target AP as part of a roaming request.

19. The non-AP device of claim 14, wherein the operations further comprise generating a one or more second nonce values using the roaming counter value and encrypting wireless traffic transmitted to the target AP using the second nonce.

20. The non-AP device of claim 19, wherein the encrypting wireless traffic transmitted to the target AP further comprises the non-AP device transmitting the roaming counter value as part of a Counter Mode Cipher (CCM) Mode Protocol (CCMP) header field or a Galois/Counter Mode Protection (GCMP) header field of an encrypted MAC Protocol Data Unit (MPDU).
